(19) United States
(12) Patent Application Publication
(10) Pub. No.: US 2004/0059652 A1
(43) Pub. Date: Mar. 25, 2004

(54) Electronic accounting method, electronic accounting server, and programming product

(75) Inventor: Osamu Yamamori, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NTT DoCoMo, Inc., Tokyo (JP)

(21) Appl. No.: 10/445,334

(22) Filed: May 27, 2003

(30) Foreign Application Priority Data
May 24, 2002 (JP) P2002-151419

(51) Int. Cl. G06F 17/60

(52) U.S. Cl. 705/30

(57) ABSTRACT

The object of the present invention is to provide an electronic accounting system which allows a recipient to make an accounting for a delivery charge of a package without paying cash to a delivery person, when receiving the package.

A server according to the present invention comprises an accounting request receiver 53 configured to receive an accounting request for the delivery charge of a package from a mobile terminal 10 of a recipient; an accounting request transmitter 54 configured to determine a financial institution system 40 which makes an accounting for the delivery charge in accordance with an invoice number included in the received accounting request, and to transmit the accounting request to the determined financial institution system 40; an accounting completion notification transmitter 56 configured to convert an accounting completion notification received from the financial institution system 40 into a symbol-formed accounting completion notification, and to transmit the symbol-formed accounting completion notification to the mobile terminal 10 of the recipient; an inquiry request receiver 57 configured to receive an inquiry request for the accounting completion notification recognized and decoded by a mobile terminal 20 of a package delivery person; and an inquiry result transmitter 58 configured to transmit the inquiry result in accordance with the inquiry request.

### CROSS REFERENCE TO RELATED APPLICATION

This application is based upon and claims the benefit of priority from the prior Japanese Patent Application No. P2002-151419, filed on May 24, 2002; the entire contents of which are incorporated herein by reference.

### BACKGROUND OF THE INVENTION

1. Field of the Invention

The present invention relates to a cashless electronic accounting method, a cashless electronic accounting server and a programming product for use therein.

2. Description of the Related Art

Conventionally, an accounting method for providing a package delivery service on a cash-on-delivery basis is known.

However, in the conventional package delivery service, a recipient makes a payment for a delivery charge of a package to a delivery person with cash, a credit card or a debit card, upon receiving the package.

Therefore the conventional package delivery service has a problem in that if the recipient cannot make a delivery charge payment, the delivery person has to return carrying the package, in the case where the recipient does not have any cash, credit cards or debit cards when receiving the package.

### BRIEF SUMMARY OF THE INVENTION

In viewing of the foregoing, it is an object of the present invention to provide an electronic accounting system, an electronic accounting server and a programming product for use therein, which allows a recipient to make an accounting for the delivery charge of a package without paying cash to a delivery person, like a transportation company's driver, when receiving the package.

A first aspect of the present invention is summarized as an electronic accounting method comprising the following steps.

In step (A), a mobile terminal of a recipient transmits an accounting request for the delivery charge of a package to a server.

In step (B), the server determines a financial institution system which makes an accounting for the delivery charge in accordance with an invoice number included in the received accounting request, and transmits the accounting request to the determined financial institution system.

In step (C) the server converts an accounting completion notification received from the financial institution system into a symbol-formed accounting completion notification, and transmits the symbol-formed accounting completion notification to the mobile terminal of the package recipient. This symbol-formed account completion notification are geometrical designed symbol, for example, barcodes, two-dimensional barcodes, and so on.

In step (D), the mobile terminal of the recipient displays the symbol-formed accounting completion notification.

In step (E), a mobile terminal of the package delivery person recognizes the symbol-formed accounting completion notification displayed on an indicator of the mobile terminal of the recipient.

In step (F), the mobile terminal of the delivery person decodes the symbol-formed accounting completion notification into the accounting completion notification, and transmits an inquiry request for the decoded accounting completion notification to the server.

In step (G), the server transmits the inquiry result in accordance with the inquiry request to the mobile terminal of the delivery person.

A second aspect of the present invention is summarized as an electronic accounting server comprising an accounting request receiver, an accounting request transmitter, an accounting completion notification transmitter, an inquiry request receiver and an inquiry result transmitter.

The accounting request receiver is configured to receive an accounting request for the delivery charge of a package from a mobile terminal of the recipient.

The accounting request transmitter is configured to determine a financial institution system which makes an accounting for the delivery charge in accordance with an invoice number included in the received accounting request, and to transmit the accounting request to the determined financial institution system.

The accounting completion notification transmitter is configured to convert an accounting completion notification received from the financial institution system into a symbol-formed accounting completion notification, and to transmit the symbol-formed accounting completion notification to the mobile terminal of the recipient.

The inquiry request receiver is configured to receive an inquiry request for the accounting completion notification recognized and decoded by a mobile terminal of the package delivery person.

The inquiry result transmitter is configured to transmit the inquiry result in accordance with the inquiry request.

A third aspect of the present invention is summarized as a programming product containing a computer readable program recorded on a computer available medium.

The program effects the functions of the accounting request receiver, the accounting request transmitter, the accounting completion notification transmitter, the inquiry request receiver and the inquiry result transmitter.

### BRIEF DESCRIPTION OF THE SEVERAL VIEWS OF THE DRAWINGS

FIG. 1 is a diagram of the entire configuration of a system for achieving an electronic accounting method according to an embodiment of the present invention.

FIG. 2 is a functional block diagram of an electronic accounting server according to the embodiment of the present invention.

FIG. 3 is a diagram exemplifying a customer database of the electronic accounting server according to the embodiment of the present invention.

FIG. 4 is a sequence diagram illustrating an electronic accounting method according to the embodiment of the present invention.

FIG. 5 is a diagram illustrating a computer available medium recording a computer readable program according to the embodiment of the present invention.

### DETAILED DESCRIPTION OF THE INVENTION

(Configuration of a System for Achieving an Electronic Accounting Method According to an Embodiment of the Present Invention)

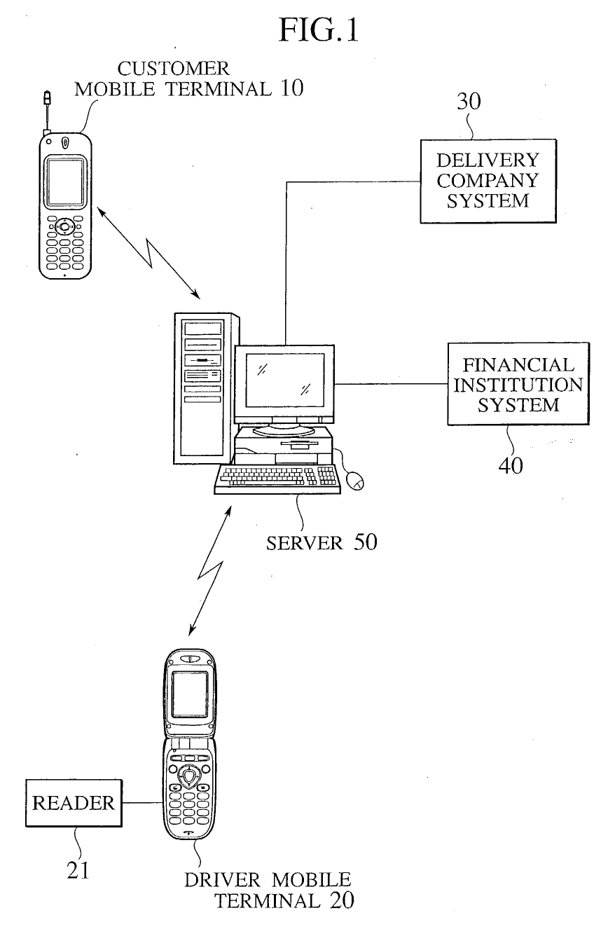

Referring to FIGS. 1 to 3, a configuration of a system for achieving an electronic accounting method according to an embodiment of the present invention will be described.

As shown in FIG. 1, the system is configured with a customer mobile terminal 10 which is a mobile terminal of a package recipient, a driver mobile terminal which is a mobile terminal 20 of a package delivery person, a delivery company system 30, a financial institution system 40 and a server 50.

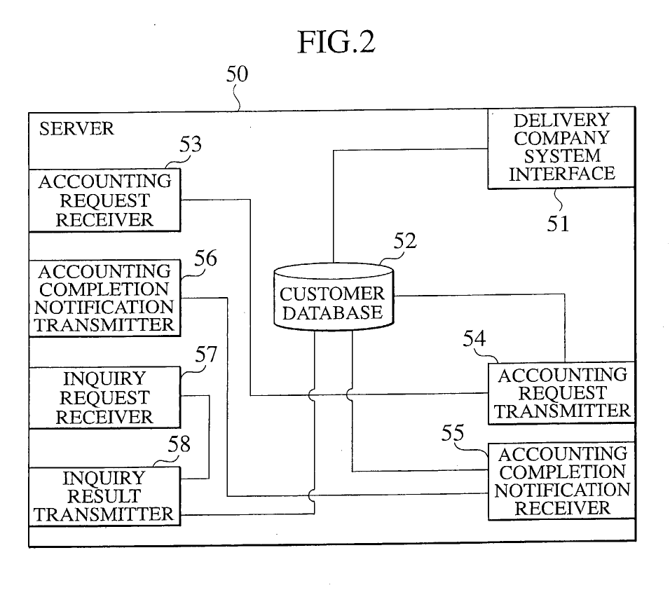

As shown in FIG. 2, the server comprises a delivery company system interface 51, a customer database 52, an accounting request receiver 53, an accounting request transmitter 54, an accounting completion notification receiver 55, an accounting completion notification transmitter 56, an inquiry request receiver 57 and an inquiry result transmitter 58.

The delivery company system interface 51, connected to the customer database 52, functions as an interface with the delivery company system 30. To be more specific, the delivery company system interface 51 receives information such as a “delivery invoice number”, a “customer ID” identifying a package recipient, a “mobile terminal ID” identifying a mobile terminal of the package recipient from the delivery company system 30, and notifies the information to the customer database 52.

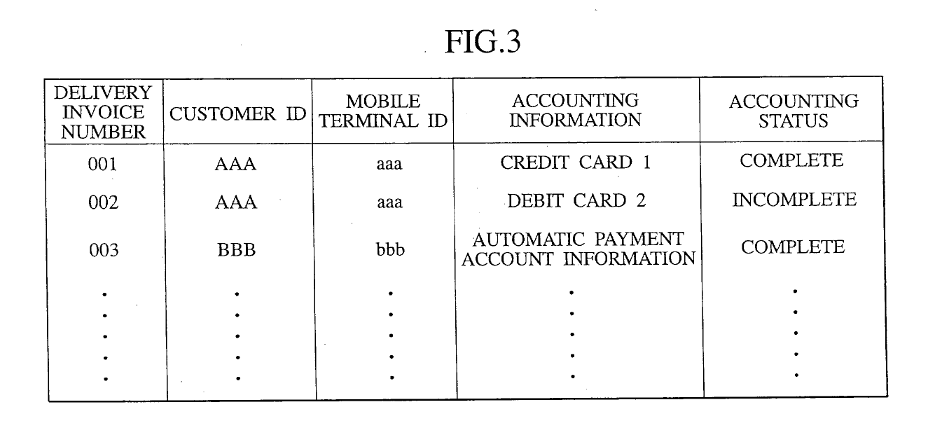

The customer database 52 stores information (delivery invoice information) regarding an accounting for the delivery charge of a package. FIG. 3 shows an example of the customer database 52.

As shown in FIG. 3, the customer database 52 stores the “delivery invoice number”, a “customer ID” identifying a package recipient, a “mobile terminal ID” identifying a mobile terminal 10 of the package recipient, “accounting information” indicating an accounting method which the recipient desires, and an “accounting status” indicating whether the accounting for the delivery charge of the package is made or not, associated with one another.

The accounting method pre-registered by the recipient (for example, a credit card ID or a debit card ID) effects the “accounting information” in the customer database 52.

When the recipient signs a contract with a specific financial institution to pay for the delivery charge of the package together with a communication charge based on another contract from his/her account (for example, a banking account) in the financial institution automatically, the automatic payment account information can effect the “accounting information”, after identifying the recipient in accordance with an authentication function by using a function of notifying the subscriber identity number of a mobile terminal.

The customer database 52 (for example, an “accounting status”) is updated in accordance with information transmitted from the delivery company system 30 or the financial institution system 40.

When the customer updates the “accounting information” in the customer database 52 before an electronic accounting via the server 50 is performed, the electronic accounting is performed based on the updated “accounting information”.

The accounting request receiver 53, connected to the accounting request transmitter 54, receives an accounting request for the delivery charge of the package from the customer mobile terminal 10. The accounting request includes a “delivery invoice number”, a “mobile terminal ID” (a number specific to a mobile terminal such as a phone number) identifying a customer mobile terminal 10, “accounting information” indicating an accounting method which a customer desires and so on.

The accounting request transmitter 54, connected to the customer database 52 and the accounting request receiver 53, determines a financial institution system 40 which makes an accounting for the delivery charge of the package in accordance with the “delivery invoice number” included in the received accounting request. The accounting request transmitter 54 transmits the accounting request to the determined financial institution system 40.

The accounting request transmitter 54 can authenticate whether the accounting request is transmitted from a correct recipient or not, by determining whether a record including the “delivery invoice number” and the “mobile terminal ID” included in the accounting request exists in the customer database 52 or not.

The accounting completion notification receiver 55, connected to the customer database 52 and the accounting completion notification transmitter 56, receives an accounting completion notification from the financial institution system 40, and transmits the received accounting completion notification to the accounting completion notification transmitter 56.

The accounting completion notification receiver 55 changes the “accounting status” in the delivery invoice information relating to the received accounting completion notification from “incompletion” to “completion”.

The accounting completion notification transmitter 56, connected to the accounting completion notification receiver 55, converts the accounting completion notification received from the accounting completion notification receiver 55 into the accounting completion notification in the form of symbols such as one-dimensional barcodes and two-dimensional barcodes (hereinafter referred to as the symbol-formed accounting completion notification). The accounting completion notification transmitter 56 transmits the symbol-formed accounting completion notification to the customer mobile terminal 10.

The inquiry request receiver 57, connected to the inquiry result transmitter 58, receives an inquiry request for the accounting completion notification from the driver mobile terminal 20. The driver mobile terminal 20 recognizes the accounting completion notification from the customer mobile terminal 10 and decodes it.

The inquiry result transmitter 58, connected to the customer database 52 and the inquiry request receiver 57, transmits the inquiry result in accordance with the inquiry request transmitted from the inquiry request receiver 57 to the driver mobile terminal 20.

To be more specific, the inquiry result transmitter 58 transmits the “accounting status” in the delivery invoice information relating to the inquiry result as the inquiry result, referring to the customer database 52, when receiving the inquiry request.

(The Electronic Accounting Method According to the Embodiment)

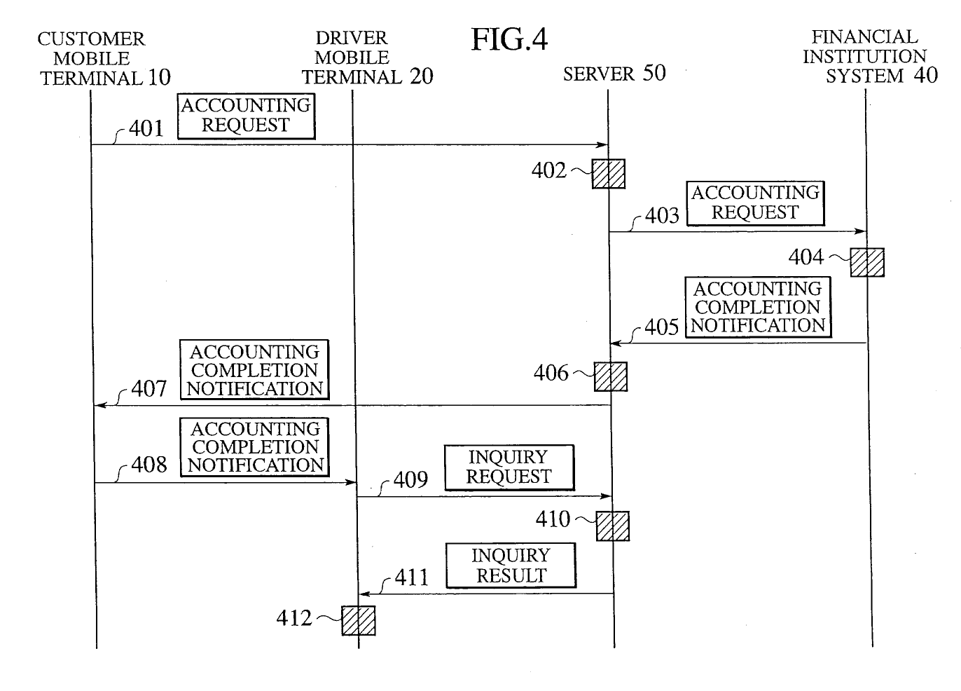

The electronic accounting method according to the embodiment will be described with reference to FIG. 4. FIG. 4 shows a sequence diagram illustrating the electronic accounting method according to the embodiment.

As shown in FIG. 4, in step 401, the package recipient transmits the accounting request including a “delivery invoice number”, a “mobile terminal ID” and “accounting information” to the server 50 using the customer mobile terminal 10, before receiving the package from the delivery person.

In step 402, the accounting request transmitter 54 of the server 50 determines a financial institution system 40 which makes an accounting for the delivery charge of the package in accordance with the “delivery invoice number” included in the accounting request received by the accounting request receiver 53.

The accounting request transmitter 54 can authenticate whether the accounting request is transmitted from a correct recipient or not, by determining whether a record including the “delivery invoice number” and the “mobile terminal ID” included in the accounting request exists in the customer database 52 or not.

In step 403, the accounting request transmitter 54 transmits the accounting request to the determined financial institution system 40. In step 404, the financial institution system 40 performs the predetermined accounting process relating to the recipient in accordance with the received accounting request. In step 405, the financial institution system 40 transmits the accounting completion notification indicating that the predetermined accounting process was completed, to the server 50.

In step 406, the accounting completion notification receiver 55 of the server 50 changes the “accounting status” in the delivery invoice information relating to the received accounting completion notification from “incompletion” to “completion”.

In step 407, the accounting completion notification transmitter 56 of the server 50 converts the accounting completion notification received via the accounting completion notification receiver 55 from the financial institution system 40 into the symbol-formed accounting completion notification, so as to transmit it to the customer mobile terminal 10.

In step 408, the package recipient displays the symbol-formed accounting completion notification on the indicator of the customer mobile terminal 10.

In step 409, the package delivery person reads the symbol-formed accounting completion notification displayed on the indicator of the customer mobile terminal 10 using a reader 21 of the driver mobile terminal 20. The delivery person transmits the inquiry request to the server using the driver mobile terminal 20, so as to verify the accounting completion notification decoded by the customer mobile terminal 20.

In step 410, the inquiry result transmitter 58 of the server 50 performs an inquiry for the received inquiry request via the inquiry request receiver 57 from the driver mobile terminal 20. In step 411, the inquiry result transmitter 58 transmits the inquiry result to the driver mobile terminal 20.

In step 412, when the inquiry result transmitted from the server 50 indicates that the delivery charge accounting for the package has been made, the delivery person hands over the package to the recipient.

(The Functions and Effects of the Electronic Accounting Method According to the Embodiment)

According to the electronic accounting method, a recipient makes an accounting for the delivery charge of a package with customer mobile terminal 10 when receiving the package, so as to allow the recipient to make a delivery charge accounting without paying cash to a delivery person or without a credit card and so on.

Therefore when the delivery person unexpectedly delivers a package and the recipient has no cash, or when the recipient hesitates to make an accounting via a credit card and so on, the recipient can make an accounting for the delivery charge.

According to the electronic accounting method, the delivery person can verify whether the recipient has made an accounting for the delivery charge or not, in accordance with the inquiry result displayed on the indicator of the driver mobile terminal 20.

According to the electronic accounting method, the delivery company can keep track of the accounting status (“complete” or “incomplete”) for the delivery charge in real-time. According to the electronic accounting method, the delivery person does not have to receive cash, so that management workload in the delivery company is reduced.

According to the electronic accounting method, the driver mobile terminal 20 verifies whether the recipient has made an accounting for the delivery charge or not, in accordance with the accounting completion notification in the form of symbols such as one-dimensional barcodes and two-dimensional barcodes, so as to prevent the recipient from falsifying whether he/she has made an accounting for the delivery charge or not.

(Modification)

Note that, in a computer 100, a program for achieving the electronic accounting method according to this embodiment can be recorded in a computer-readable recording medium.

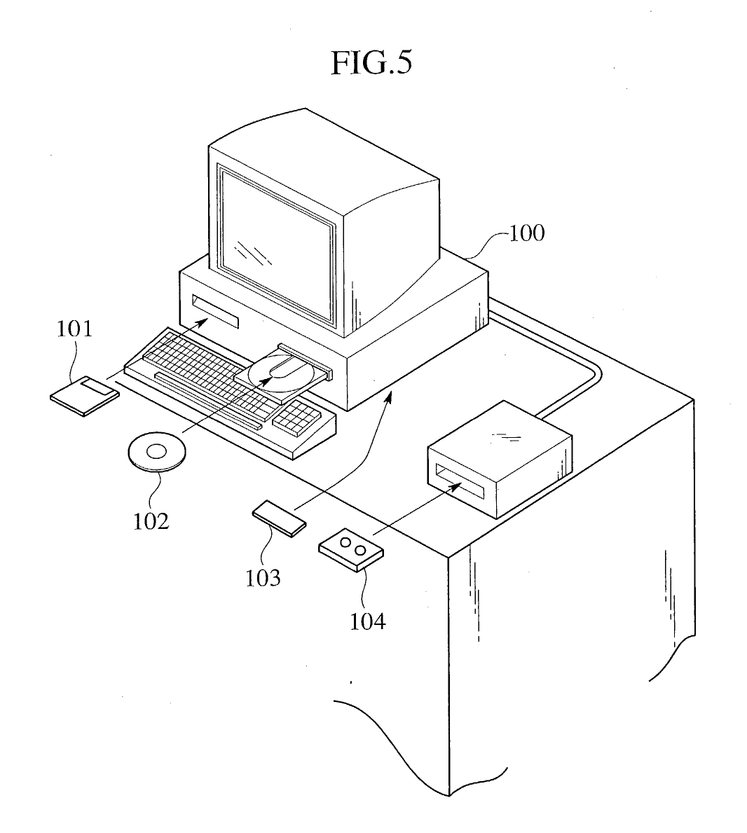

As shown in FIG. 5, examples of the computer-readable recording medium including a floppy disk 101, a compact disc 102, an IC chip 103, a cassette tape 104 and the like are given. According to the computer-readable recording medium recording the program, the program is able to be easily stored transferred, sold and the like.

(The Functions and Effects of the Present Invention)

According to the prevent invention, an electronic accounting system, an electronic accounting server and a programming product for use therein, which allows a recipient to make an accounting for the delivery charge of a package without paying cash to a delivery person when receiving the package, can be provided.

Additional advantages and modifications will readily occur to those skilled in the art. Therefore, the invention in its broader aspects is not limited to the specific details and the representative embodiment shown and described herein. Accordingly, various modifications may be made without departing from the spirit or scope of the general inventive concept as defined by the appended claims and their equivalents.

What is claimed is:

1. An electronic accounting method comprising the steps of:
(A) transmitting, in a mobile terminal of a package recipient, an accounting request for the package to a server;
(B) determining, in the server, a financial institution system which makes an accounting for the package in accordance with an invoice number included in the received accounting request, and transmitting the accounting request to the determined financial institution system;
(C) converting, in the server, an accounting completion notification received from the financial institution system into a symbol-formed accounting completion notification, and transmitting the symbol-formed accounting completion notification to the mobile terminal of the recipient;
(D) displaying, in the mobile terminal of the recipient, the symbol-formed accounting completion notification;
(E) recognizing, in a mobile terminal of a package delivery person, the symbol-formed accounting completion notification displayed on the indicator of the mobile terminal of the recipient;
(F) decoding, in the mobile terminal of the delivery person, the symbol-formed accounting completion notification into the accounting completion notification, and transmitting an inquiry request for the decoded accounting completion notification to the server; and
(G) transmitting, in the server, the inquiry result in accordance with the inquiry request to the mobile terminal of the delivery person.

2. An electronic accounting server comprising:
an accounting request receiver configured to receive an accounting request for a package from a mobile terminal of a package recipient;
an accounting request transmitter configured to determine a financial institution system which makes an accounting for the package in accordance with an invoice number included in the received accounting request, and to transmit the accounting request to the determined financial institution system;
an accounting completion notification transmitter configured to convert an accounting completion notification received from the financial institution system into a symbol-formed accounting completion notification, and to transmit the symbol-formed accounting completion notification to the mobile terminal of the recipient;
an inquiry request receiver configured to receive an inquiry request for the accounting completion notification recognized and decoded by a mobile terminal of a package delivery person; and
an inquiry result transmitter configured to transmit the inquiry result in accordance with the inquiry request.

3. A programming product containing a computer readable program recorded on a computer available medium, the program effecting the functions of:
an accounting request receiver configured to receive an accounting request for a package from a mobile terminal of a package recipient;
an accounting request transmitter configured to determine a financial institution system which makes an accounting for the package in accordance with an invoice number included in the received accounting request, and to transmit the accounting request to the determined financial institution system;
an accounting completion notification transmitter configured to convert an accounting completion notification received from the financial institution system into a symbol-formed accounting completion notification, and to transmit the symbol-formed accounting completion notification to the mobile terminal of the recipient;
an inquiry request receiver configured to receive an inquiry request for the accounting completion notification recognized and decoded by a mobile terminal of a package delivery person; and
an inquiry result transmitter configured to transmit the inquiry result in accordance with the inquiry request.
